(19) United States
(12) Patent Application Publication
(10) Pub. No.: US 2014/0162009 A1
(43) Pub. Date: Jun. 12, 2014

(54) SHOCK ABSORPTION FILM AND METHOD OF MAKING THE SAME

(71) Applicant: SHE HWA P&C CO., LTD, Yongin-si (KR)

(72) Inventor: Byoung-Woo HWANG, Yongin-si (KR)

(73) Assignee: SHE HWA P&C CO., LTD, Yongin-si (KR)

(21) Appl. No.: 13/900,394

(22) Filed: May 22, 2013

(30) Foreign Application Priority Data
Dec. 12, 2012 (KR) 10-2012-0144486

(51) Int. Cl. G06F 1/16; C09J 7/02; B32B 7/12

(52) U.S. Cl. CPC G06F 1/1656; B32B 7/12; C09J 7/0296
USPC 428/41.4; 428/354; 428/337; 428/336; 427/207.1; 156/329

(57) ABSTRACT

The present disclosure generally relates to a shock absorption film for use with a mobile computing device. The shock absorption film includes, for example, a PET base layer; a TPU-based layer comprising a thermoplastic polyurethane (TPU) material; a release liner; a glue layer interposed between the base layer and the TPU layer; and a silicone-based adhesive layer interposed between the TPU layer and the release liner, the silicone-based adhesive layer contacting the TPU layer without an intervening layer between the silicone adhesive layer and the TPU layer.

### FIELD OF THE INVENTION

The present invention relates to a shock absorption film and method of making the same.

### BACKGROUND

In recent year, the conventional IT devices, for example mobile phone and notebook computer are replaced with smartphones or tablet PCs. Then, for satisfaction of user's need and convenience, those smartphones or tablet PCs are developed to the direction of enlarging in display size and getting thinner in vessel and frame thickness around the display window, which enhances risk of breaking or cracking of the display window caused by a shock like drop of the smartphone or tablet PC from the user's hand to the floor by mistake.

The display window of those smartphone or tablet PC is a touch screen and also plays a role as an input device as well as a screen displaying mobile contents. When user meets a situation of a display window breaking or cracking, therefore, one should fix or replace a damaged display window. A touch screen type display window is very expensive, which burdens the user heavily. Therefore, many protection films attached on the surface of a display window of a smartphone or tablet PC have been developed to protect a display window. When a protection film is attached, by the way, the touch sensitivity and correctness of the touch screen has the tendency of decrease with the protection film thickness attached thereon. Therefore, the thickness of a conventional protection film attached to the surface of a touch screen is limited to 400-500 micrometers.

Polyethylene terephthalate (PET) film having the thickness of 150 to 200 micrometers is most generally used as a protection film for touch screen, which shows a poor elasticity and is inadequate for display window protection from the shock or impact in spite of a good mechanical strength and transparency. Therefore, thermoplastic polyurethane(TPU) showing an excellent elasticity, shock absorption as well as high transparency is preferable as a shock absorption or protection film for a display window of a touch screen. Korean Patent laid-open No. 10-2010-0102788 disclosed a cover film for display comprising a transparent film layer, a TPU layer on said transparent film layer and an adhesive layer bonding said transparent film layer and TPU layer.

However, a conventional protection film comprising a TPU layer would have 500 micrometers over thickness, because a TPU layer is so pliant and vulnerable to a heat that a silicone adhesive, which is known as being adequate for adhesion to a glassware or plastic panel like touch screen and requiring about 180° C. to coat it on a substrate, would not be coated thereon directly. Therefore, other PET film having the thickness up to or over 100 micrometers should be inserted between a TPU layer and an adhesive layer, which makes a protection film thickened up to or over 500 micrometers thickness, deteriorates the optical properties, touch sensitivity and input correctness of a touch screen and increases production cost. Moreover, further functional layers like anti-bacteria and/or hard-coating layer may not be added to a protection film comprising a TPU layer, because the thickness of a TPU layer should be over 200 micrometers in order to exhibit sufficient shock absorption effect, that of PET film layers positioned on both side of the TPU layer should be at least 100 micrometers and that of the adhesive layers between said TPU layer and the each PET film layers is 20 to 50 micrometers, so the thickness of the protection film would be up to or over 500 micrometers.

An acrylate-based adhesive can be an alternative for a silicone-based adhesive adaptable to a TPU film directly in considering no further heating in coating it on a TPU film. However, an acrylate-based adhesive has many problems of making difficulty in attaching and detaching the protection film applying said acrylate-based adhesive, air bubble occurrence at the interface of adhesive layer and display window, adhesive remaining in time of detaching the protection film from a display window, due to too high adhesion force thereof.

This section is to provide general background information related to the shock absorption film. Nothing in this section constitutes an admission of prior art.

### SUMMARY

One aspect of the invention provides a shock absorption film comprising: a base layer; a TPU-based layer comprising a thermoplastic polyurethane (TPU) material, the TPU-based layer comprising a first surface and a second surface facing away from the first surface; a glue layer interposed between the base layer and the first surface of the TPU-based layer; and a silicone-based adhesive layer formed on the second surface of the TPU-based layer, the silicone-based adhesive layer contacting the TPU-based layer without an intervening layer between the silicone adhesive layer and the TPU-based layer.

In the foregoing shock absorption film, the silicone-based adhesive layer may comprise a cured form of a composition, which may comprise: a polydimethylsiloxane-based silicone adhesive compound; a silicone-based cross-linking agent comprising a Si-H group; an anchorage enhancing agent; and at least one metal catalyst selected from the group consisting of Pt, Ru, Os, Rh, Ir and Pd3. The composition may comprise: 100 parts of the polydimethylsiloxane-based silicone adhesive compound; about 1 to about 10 parts of the silicone-based cross-linking agent; about 1 to about 5 parts of the anchorage enhancing agent; and about 1 to about 5 parts of the at least one metal catalyst. The anchorage enhancing agent may comprise a silane coupling agent or a complex between a silane coupling agent and polydimethylsiloxane.

In the foregoing shock absorption film, the silicone-based adhesive layer may be cured from a composition at a temperature between about 140° C. and about 180° C., the composition may comprise: a polydimethylsiloxane-based silicone adhesive compound; a silicone-based cross-linking agent comprising a Si-H group; an anchorage enhancing agent; and at least one metal catalyst selected from the group consisting of Pt, Ru, Os, Rh, Ir and Pd3. The composition may comprise: 100 parts of the polydimethylsiloxane-based silicone adhesive compound; about 1 to about 10 parts of the silicone-based cross-linking agent; about 1 to about 5 parts of the anchorage enhancing agent; and about 1 to about 5 parts of the at least one metal catalyst. The anchorage enhancing agent may comprise a silane coupling agent or a complex between a silane coupling agent and polydimethylsiloxane.

In the foregoing shock absorption film, the base layer may comprise polyethylene terephthalate (PET). The base layer may have a thickness in the range of about 80 μm to about 120 μm. The TPU-based layer may have a thickness in the range of about 200 μm to about 300 μm. The shock absorption film may have a thickness in the range of about 350 μm to about 450 μm. The film may further comprise a release liner, wherein the silicone-based adhesive layer is interposed between the TPU-based layer and the release liner. The film may further comprise either or both of an anti-bacterial layer and a hard coating layer.

Another aspect of the invention provides a mobile computing device comprising a display screen and the foregoing shock absorption film applied onto the display screen such that the silicone-based adhesive layer contacts a surface of the display screen. The device is selected from the group consisting of a mobile phone, a smart phone, a tablet computer, and a notebook computer.

Another aspect of the invention provides a method of making a shock absorption film. The method comprises: providing the TPU-based layer comprising a thermoplastic polyurethane (TPU) material; applying an adhesive composition onto the TPU-based layer such that the adhesive composition contacts the TPU-based layer; and curing the adhesive composition to provide the silicone-based adhesive layer by heat-treating both the TPU-based layer and the adhesive composition together at a temperature about 180° C. or lower. The adhesive composition may comprise a polydimethylsiloxane-based silicone adhesive compound, a silicone-based cross-linking agent comprising a Si—H group, an anchorage enhancing agent, and at least one metal catalyst selected from the group consisting of Pt, Ru, Os, Rh, Ir and Pd3; curing the adhesive composition to provide the silicone-based adhesive layer by heat-treating both the TPU-based layer and the adhesive composition together at a temperature about 180° C. or lower.

In the foregoing method, the temperature is between about 140° C. and about 180° C. Providing the TPU-material layer may comprise: providing the base layer; and bonding the TPU-based layer with the glue layer between the base layer and the TPU-based layer. The shock absorption film may have a thickness in the range of about 400 μm to about 450 μm. The composition may comprise: 100 parts of the polydimethylsiloxane-based silicone adhesive compound; about 1 to about 10 parts of the silicone-based cross-linking agent; about 1 to about 5 parts of the anchorage enhancing agent; and about 1 to about 5 parts of the at least one metal catalyst.

### BRIEF DESCRIPTION OF THE DRAWINGS

FIG. 1 is a cross-sectional view of a conventional protection film comprising a TPU film layer, two PET film layer positioned on each side of said TPU film layer, two acrylate-based adhesive layers formed and bonding said TPU film layer and the PET film layer and silicone-based adhesive layer formed on one side of one of those PET film layer.

FIG. 2 is a cross-sectional view of a shock absorption film according to the present invention.

### DETAILED DESCRIPTION OF EMBODIMENTS

Hereinafter, an adhesive composition and a shock absorption film will be described with reference to Figures of the accompanying drawings.

An adhesive composition for a TPU film according to an embodiment of the present invention comprises polydimethylsiloxane-based silicone adhesive compound 100 parts, silicone cross-linking agent comprising Si—H group 1 to 10 parts, anchorage enhancing agent 1 to 5 parts and metal catalyst at least one selected from the group consisting of Pt, Ru, Os, Rh, Ir and Pd.

In the adhesive composition for a TPU film according to the present invention, a polydimethylsiloxane-based silicone adhesive compound is preferable for adhesive component of a display window protection film due to its specificity of excellent thermostability, solvent resistance, weather stability and long term stability and so forth. Commercial silicone-based adhesive, for example Dow-corning 7645, 7646, 7652 7657 or mixture thereof is available for a silicone-based adhesive compound of adhesive composition for a TPU film according to the present invention.

An adhesive composition for a TPU film according to the present invention comprises a silicone-based cross-linking agent comprising Si—H group in amount of 1 to 10 parts preferably, 2 to 5 parts more preferably, in comparison with the polydimethylsiloxane-based silicone adhesive compound 100 parts. In case that the amount of the silicone-based cross-linking agent comprising Si-H group is less than 1 part in comparison with the polydimethylsiloxane-based silicone adhesive compound 100 parts, cross-linking density in the composition is too low so that long term stability would fall off. Whereas the amount of the silicone-based cross-linking agent comprising Si-H group would be more than 10 parts in comparison with the polydimethylsiloxane-based silicone adhesive compound 100 parts, cross-linking density in the composition is too high so that hardness of the composition would ascend and the adhesion force would be declined.

An adhesive composition for a TPU film according to the present invention comprises an anchorage enhancing agent in amount of 1 to 5 parts in comparison with the polydimethylsiloxane-based silicone adhesive compound 100 parts. An anchorage enhancing agent plays a role as enhancing sticking force to a substrate. A preferable compound as an anchorage enhancing agent of the present invention is silane coupling agent or a complex of silane coupling agent and polydimethylsiloxane, for example Dow-Corning 9176 and 9250. In case that the amount of the anchorage enhancing agent is less than 1 part in comparison with the polydimethylsiloxane-based silicone adhesive compound 100 parts, the effect of addition would fall off. Whereas the amount of the anchorage enhancing agent would be more than 5 parts in comparison with the polydimethylsiloxane-based silicone adhesive compound 100 parts, there is no more effect according to the further addition.

An adhesive composition for a TPU film according to the present invention comprises a metal catalyst at least one selected from the group consisting of Pt, Ru, Os, Rh, Ir and Pd in amount of 1 to 5 parts in comparison with the polydimethylsiloxane-based silicone adhesive compound 100 parts. A metal catalyst is used for controlling speed of the catalytic cross-linking reaction and hardening of said silicone-based cross-linking agent comprising Si—H group in the adhesive composition according to an embodiment of the present invention. In case that the amount of the metal catalyst is less than 1 part in comparison with the polydimethylsiloxane-based silicone adhesive compound 100 parts, which slow down the hardening of the adhesive composition. When the amount of the metal catalyst would be more than 5 parts in comparison with the polydimethylsiloxane-based silicone adhesive compound 100 parts, it would harden the adhesive composition according to an embodiment of the present invention too excessively and make the adhesive composition get yellowing.

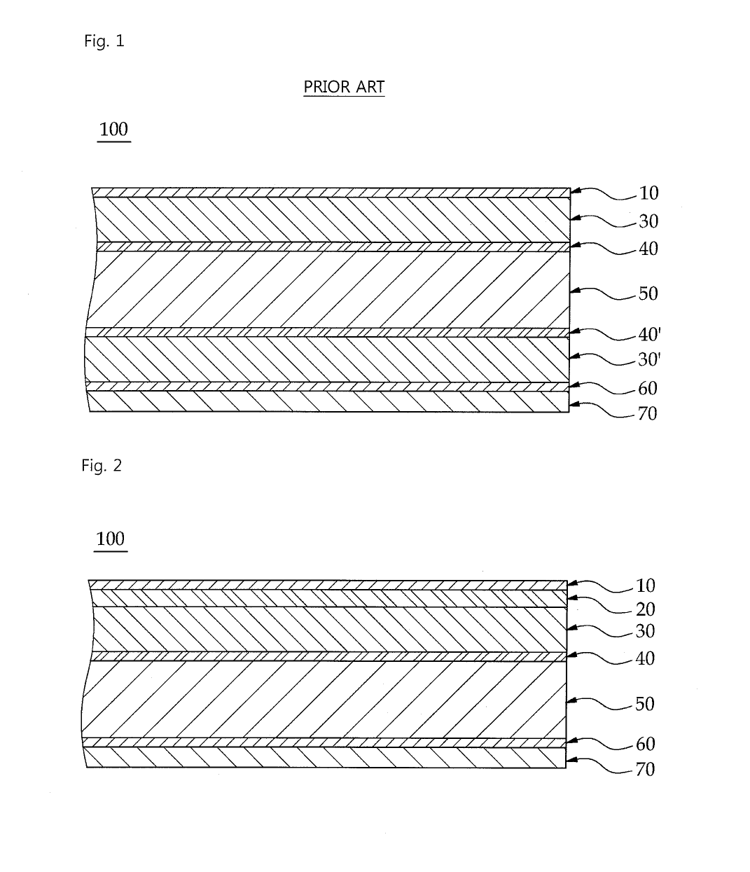

Also, an embodiment of the present invention provides a shock absorption film (100) having an adhesive layer (60) comprising said adhesive composition. FIG. 2 is a cross-sectional view of a shock absorption film (100) according to an embodiment of the present invention. As shown in FIG. 2, a shock absorption film (100) according to an embodiment of the present invention comprises a) PET base film layer (30), b) a glue layer (40) formed on a side of said PET base film layer (30), c) a TPU film layer (50), one side of said TPU film layer (50) bonded with said PET base film layer (30) through said glue layer (40) and d) the adhesive layer (60) comprising said adhesive composition formed on another side of said TPU film layer. In comparison with the conventional shock absorption film as shown in FIG. 1, a shock absorption film (100) according to an embodiment of the present invention does not need a PET film layer (30′) inserted between a silicone-based adhesive (60) and TPU film layer (50) and a glue layer (40′) bonding said PET film layer (30′) and said TPU film layer (50), which is required indispensably in the conventional shock absorption film adapting TPU film layer. Therefore, it is possible to add other functional layer, for example an anti-bacterial and/or hard coating layer on a shock absorption film (100) according to an embodiment of the present invention due to coating a silicone-based adhesive on TPU film layer directly.

As aforementioned, the thickness of a PET base film layer (30) is more than 100 micrometers, 100 to 120 micrometers preferably, in order to prevent deformation of a shock absorption film (100) and that of a TPU film layer (50) is more than 200 micrometers in order to endow a sufficient shock absorption effect. Preferably, the thickness of a TPU film layer (50) is in the range of 200 to 300 micrometers in considering that the whole thickness of a shock absorption film should be less than 500 micrometers, as described before.

The shock absorption film according to an embodiment of the present invention may be fabricated as bellows; firstly, a PET base film (30) with protection film (10) is put together with a TPU film through an acrylate-based glue. At this point, the thickness of a PET base film (30) should be over 100 micrometers for preventing thermal deformation of a TPU film (50) and the thickness of a TPU film (50) should be over 200 micrometers for adequate shock absorption.

As aforementioned, a shock absorption film according to an embodiment of the present invention is enabled to be thinner than a conventional shock absorption film due to direct coating of adhesive layer on a TPU film, so that other functional layer (20), for example an anti-bacterial and/or hard coating layer can be added on another side of the PET film layer (30). Finally, the thickness of the shock absorption film (100) is in the range of 400 to 450 micrometer, so that there are no aforementioned problems like deterioration of touch sense and input error in touching screen.

The present invention will be described below in greater detail in connection with examples according to certain embodiments of the present invention. It should be noted that the following embodiments are provided merely for better understanding of the invention and the scope of the present invention is not limited only to the embodiments.

### EXAMPLE 1

An adhesive composition was prepared by mixing polydimethylsiloxane-based compound Dow Corning 7645 100 g as a silicone-based adhesive, Dow Corning 7689 3 g as a cross-linking agent, Dow Corning 9176 3 g as an anchorage enhancing agent and Pt catalyst 1.5 g.

### EXAMPLE 2

An adhesive composition was prepared by mixing polydimethylsiloxane-based compound Dow Corning 7646 90 g and Dow Corning 7657 10 g as a silicone-based adhesive, Dow Corning 7689 3 g as a cross-linking agent, Dow Corning 9176 3 g as an anchorage enhancing agent and Pt catalyst 2 g.

### EXAMPLE 3

An adhesive composition was prepared by mixing polydimethylsiloxane-based compound Dow Corning 7645 100 g as a silicone-based adhesive, Dow Corning 7689 3 g as a cross-linking agent, Dow Corning 9176 3 g as an anchorage enhancing agent and Pt catalyst 2 g.

### Comparative Example 1

An adhesive composition was prepared by mixing polydimethylsiloxane-based compound Dow Corning 7645 100 g as a silicone-based adhesive, Dow Corning 7689 3 g as a cross-linking agent, Dow Corning 9176 3 g was used as an anchorage enhancing agent and Pt catalyst 0.5 g.

### Comparative Example 2

An adhesive composition was prepared by mixing catalyst containing polydimethylsiloxane-based compound SG6370A (KCC, Republic of Korea) 70 g and SG6480A (KCC) 30 as a silicone-based adhesive and SK0010C (KCC) 2 g as a cross-linking agent.

### Comparative Example 3

An adhesive composition was prepared by mixing and polymerizing methylmetacrylate 70 g, acrylic acid 10 g and 2-hydroxyethyl metacrylate 20 g as an acrylate-based adhesive and isocyante-based hardening agent 2 g.

Adhesive compositions prepared in above examples and comparative examples were coated on TPU film by 30 micrometers thickness, respectively. After 1 minute of hardening in 150° C. oven, physical properties and durability of adhesive layers were tested and the results were arranged in Table 1.

TABLE 1

| | | | durablity³⁾ | | |
|---|---|---|---|---|---|
| | Adhesive | Hardeness | Adhesive | Transcrip- | deforma- |
| | Force¹⁾ | condition²⁾ | Force | tion | tion |
| Example 1 | 6 | Good | 10 | N | None |
| Example 2 | 7 | Good | 18 | N | None |
| Comparative | 3 | Bad | 9 | Y | None |
| example 1 | | | | | |
| Comparative | 2 | Bad | 15 | Y | None |
| example 2 | | | | | |
| Comparative | 400 | good | 1200 | Y | whitening |
| example 3 | | | | | |

¹⁾g/25 mm, glass, adhesive force was measured by KS T1028 method
²⁾Hardness was measured by observing whether the adhesive transcription to a glass in attaching and detaching to and from a glass surface or not.
³⁾Durability was measured after the TPU films with the respective adhesive layers were maintained at 85° C. and 85% of humidity in 3 days.

As shown in table 1, the adhesive component an embodiment of according to the present invention is excellent in physical properties and durability in comparison with the comparative examples adapting conventional acrylate adhesives.

It is intended that the embodiments of the present invention described above should not be construed as limiting the technical spirit of the present invention. The scope of the present invention is defined only by the appended claims. Those skilled in the art can make various changes and modifications thereto without departing from the spirit. Therefore, various changes and modifications obvious to those skilled in the art will fall within the scope of the present invention.

What is claimed is:

1. A shock absorption film comprising:
a base layer;
a TPU-based layer comprising a thermoplastic polyurethane (TPU) material, the TPU-based layer comprising a first surface and a second surface facing away from the first surface;
a glue layer interposed between the base layer and the first surface of the TPU-based layer; and
a silicone-based adhesive layer formed on the second surface of the TPU-based layer, the silicone-based adhesive layer contacting the TPU-based layer without an intervening layer between the silicone adhesive layer and the TPU-based layer.

2. The film of claim 1, wherein the silicone-based adhesive layer comprising a cured form of a composition comprising:
a polydimethylsiloxane-based silicone adhesive compound;
a silicone-based cross-linking agent comprising a Si-H group;
an anchorage enhancing agent; and
at least one metal catalyst selected from the group consisting of Pt, Ru, Os, Rh, Ir and Pd3.

3. The film of claim 2, wherein the composition comprises:
100 parts of the polydimethylsiloxane-based silicone adhesive compound;
about 1 to about 10 parts of the silicone-based cross-linking agent;
about 1 to about 5 parts of the anchorage enhancing agent; and
about 1 to about 5 parts of the at least one metal catalyst.

4. The film of claim 2, wherein the anchorage enhancing agent comprises a silane coupling agent or a complex between a silane coupling agent and polydimethylsiloxane.

5. The film of claim 1, wherein the silicone-based adhesive layer is cured from a composition at a temperature between about 140° C. and about 180° C., the composition comprising:
a polydimethylsiloxane-based silicone adhesive compound;
a silicone-based cross-linking agent comprising a Si-H group;
an anchorage enhancing agent; and
at least one metal catalyst selected from the group consisting of Pt, Ru, Os, Rh, Ir and Pd3.

6. The film of claim 5, wherein the composition comprises:
100 parts of the polydimethylsiloxane-based silicone adhesive compound;
about 1 to about 10 parts of the silicone-based cross-linking agent;
about 1 to about 5 parts of the anchorage enhancing agent; and
about 1 to about 5 parts of the at least one metal catalyst.

7. The film of claim 5, wherein the anchorage enhancing agent comprises a silane coupling agent or a complex between a silane coupling agent and polydimethylsiloxane.

8. The film of claim 1, wherein the base layer comprises polyethylene terephthalate (PET).

9. The film of claim 1, wherein the base layer has a thickness in the range of about 80 μm to about 120 μm.

10. The film of claim 1, wherein the TPU-based layer has a thickness in the range of about 200 μm to about 300 μm.

11. The film of claim 1, wherein the shock absorption film has a thickness in the range of about 350 μm to about 450 μm.

12. The film of claim 1, further comprising a release liner, wherein the silicone-based adhesive layer is interposed between the TPU-based layer and the release liner.

13. The film of claim 1, further comprising either or both of an anti-bacterial layer and a hard coating layer.

14. A mobile computing device comprising a display screen and the shock absorption film of claim 1 applied onto the display screen such that the silicone-based adhesive layer contacts a surface of the display screen.

15. The device of claim 14, wherein the device is one selected from the group consisting of a mobile phone, a smart phone, a tablet computer, and a notebook computer.

16. A method of making a shock absorption film of claim 1, the method comprising:
providing the TPU-based layer comprising a thermoplastic polyurethane (TPU) material;
applying an adhesive composition onto the TPU-based layer such that the adhesive composition contacts the TPU-based layer, the adhesive composition comprising:
a polydimethylsiloxane-based silicone adhesive compound,
a silicone-based cross-linking agent comprising a Si-H group,
an anchorage enhancing agent, and
at least one metal catalyst selected from the group consisting of Pt, Ru, Os, Rh, Ir and Pd3; and
curing the adhesive composition to provide the silicone-based adhesive layer by heat-treating both the TPU-based layer and the adhesive composition together at a temperature about 180° C. or lower.

17. The method of claim 16, wherein the temperature is between about 140° C. and about 180° C.

18. The method of claim 16, wherein providing the TPU-material layer comprises:
providing the base layer; and
bonding the TPU-based layer with the glue layer between the base layer and the TPU-based layer.

19. The method of claim 16, wherein the shock absorption film has a thickness in the range of about 400 μm to about 450 μm.

20. The method of claim 16, wherein the composition comprises:
100 parts of the polydimethylsiloxane-based silicone adhesive compound;
about 1 to about 10 parts of the silicone-based cross-linking agent;
about 1 to about 5 parts of the anchorage enhancing agent; and
about 1 to about 5 parts of the at least one metal catalyst.
